(19) United States
(12) Patent Application Publication
(10) Pub. No.: US 2023/0258567 A1
(43) Pub. Date: Aug. 17, 2023

(54) PAINTED SUBSTRATE FOR SPECTROSCOPY

(71) Applicant: Botanisol Analytics, Inc., Boston, MA (US)

(72) Inventors: David Talenfeld, Boston, MA (US); Cinara de Oliveira Machado Talenfeld, Boston, MA (US)

(21) Appl. No.: 18/169,557

(22) Filed: Feb. 15, 2023

Related U.S. Application Data
(60) Provisional application No. 63/310,760, filed on Feb. 16, 2022.

(51) Int. Cl. G01N 21/65; B82Y 30/00; B82Y 15/00

(52) U.S. Cl. CPC G01N 21/658; B82Y 30/00; B82Y 15/00

(57) ABSTRACT

The subject matter described herein relates to systems, methods, and apparatus for performing surface-enhanced Raman spectroscopy (SERS). An example method includes: providing a substrate; providing a paint containing enhancement particles; and applying a layer of the paint to at least a portion of the substrate to form a coated substrate. The coated substrate is configured for use in a SERS process.

### CROSS-REFERENCE TO RELATED APPLICATIONS

This application claims the benefit of U.S. Provisional Patent Application No. 63/310,760, filed Feb. 16, 2022, the entire contents of which are incorporated by reference herein.

### TECHNICAL FIELD

In various embodiments, the subject matter of this disclosure relates to Raman spectroscopy and, more particularly, to the use of painted substrates in surface-enhanced Raman spectroscopy (SERS).

### BACKGROUND

Raman spectroscopy is a technique used to identify molecules. When molecules are exposed to a light source, interactions between the light and the molecules can result in an upward or downward shift in photons, which provides a signal associated with vibrational modes of the molecules. The signal can be enhanced by placing the molecules on particular surfaces, to achieve surface-enhanced Raman spectroscopy (SERS). A spectrum in the enhanced signal can be uniquely identifiable to a specific molecule.

Suitable surfaces for SERS can be formed from materials containing metals such as copper, gallium, gold, iridium, lead, platinum, silver, or mixtures thereof. The materials can be deposited on silicon chips or other substrates using sputtering, electroplating, physical vapor deposition, crystalline growth, chemical mixing, liquid adsorption, or similar techniques.

### SUMMARY

In various embodiments, the invention relates to a method and system for preparing a coated substrate for use in surface-enhanced Raman spectroscopy (SERS). In a typical example, a layer of paint (or ink) containing microparticles and/or nanoparticles (e.g., silver nanoparticles) is applied to a substrate (e.g., a microscope slide) using a coating process, such as spray coating. Once the paint is dry, a test sample can be applied to the dried paint, and SERS can be used to detect a component in the test sample. The component can be, for example, a molecule, a virus, a biological agent, a disease state, a protein, a biomarker, an explosive, contraband, a chemical agent, an industrial chemical, a bacterium, a polymer, an impurity, a molecular artifact, a component related to process chemistry quality control, or any other SERS-detectable component.

In general, in one aspect, the subject matter of this disclosure relates to a method that includes: providing a substrate; providing a paint including enhancement particles; and applying a layer of the paint to at least a portion of the substrate to form a coated substrate, wherein the coated substrate is configured for use in a surface-enhanced Raman spectroscopy (SERS) process.

In certain examples, the substrate can be or include a microscope slide. The enhancement particles can be or include metallic microparticles or metallic nanoparticles. The paint can include a binder. Applying the layer of the paint can include using a coating process, and the coating process can include spray coating, roll coating, brush coating, dip coating, blade coating, and/or curtain coating. Providing the coated microscope slide for use in the SERS process can include preventing oxidation of the enhancement particles. The SERS process can be used to detect a component in a test sample disposed on the paint. The component can be or include a molecule, a virus, a biological agent, a disease state, a protein, a biomarker, an explosive, contraband, a chemical agent, an industrial chemical, a bacterium, a polymer, an impurity, a component related to process chemistry quality control, a molecular artifact, a chemical spectral fingerprint, a biological spectral fingerprint, or any combination thereof. The substrate can include a sample containment feature, such as a silicone isolator, a concave surface, a sample well, a sample vial, a textured surface, a porous surface, or a porous membrane.

In another aspect, the subject matter of this disclosure relates to a method that includes: obtaining a coated substrate having a coating of paint including enhancement particles; applying a test sample to the paint; and using surface-enhanced Raman spectroscopy (SERS) to detect a component in the test sample.

In some implementations, the coated substrate can include a microscope slide, a silicone isolator, a concave sample well, a vial, a well plate, paper, a membrane, or a porous material. The enhancement particles can be or include metallic microparticles or metallic nanoparticles. The component can be or include a molecule, a virus, a biological agent, a disease state, a protein, a biomarker, an explosive, contraband, a chemical agent, an industrial chemical, a bacterium, a polymer, an impurity, a molecular artifact, a component related to process chemistry quality control, a chemical spectral fingerprint, a biological spectral fingerprint, or any combination thereof.

In another aspect, the subject matter of this disclosure relates to a system that includes: a coated substrate having a coating of paint including enhancement particles; and a surface-enhanced Raman spectroscopy (SERS) device, wherein a test sample is applied to the paint and the SERS device is used to detect a component in the test sample.

In various examples, the enhancement particles can be or include metallic microparticles or metallic nanoparticles. The component can include at least one of a molecule, a virus, a biological agent, a disease state, a protein, a biomarker, an explosive, contraband, a chemical agent, an industrial chemical, a bacterium, a polymer, an impurity, a molecular artifact, a component related to process chemistry quality control, or any combination thereof.

In another aspect, the subject matter of this disclosure relates to an apparatus that includes: a microscope slide; and a paint disposed on at least a portion of the microscope slide, the paint including metallic enhancement particles.

In certain instances, the metallic enhancement particles can include silver. The apparatus can be configured for use in a surface-enhanced Raman spectroscopy (SERS) device. The apparatus can include a silicone isolator disposed on the microscope slide and surrounding at least a portion of the paint.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings.

FIG. 1 is a schematic top view of a coated substrate having a layer of paint containing microparticles and/or nanoparticles, in accordance with certain embodiments of the invention.

FIG. 2 is a photograph of multiple coated substrates, in accordance with certain embodiments of the invention.

FIG. 3 is a flowchart of an example method of manufacturing a coated substrate, in accordance with certain embodiments of the invention.

FIG. 4 is a plot of a SERS spectrum obtained for a layer of paint containing microparticles and/or nanoparticles, in accordance with certain embodiments of the invention.

FIGS. 5-7 are plots of SERS spectra obtained for test samples disposed on a layer of paint containing microparticles and/or nanoparticles, in accordance with certain embodiments of the invention.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art and are considered to be within the scope of the disclosed invention.

It should be understood that the order of steps or order for performing certain actions is immaterial, so long as the invention remains operable. Moreover, two or more steps or actions may be conducted simultaneously.

In various examples, “paint” can refer to a material that contains enhancement particles and converts to a solid film after being applied as a layer to a substrate. Paint can include enhancement particles (e.g., microparticles or nanoparticles of metal or other materials), binders (e.g., oil-based binders, latex binders, or acrylic binders), solvents (e.g., paint thinner or water), and/or additives (e.g., thickening agents, surfactants, homogenizers, biocides, fillers, talc, etc.). In general, the enhancement particles are suspended in a mixture of the binder, solvent, and additives. When applied as a film to a substrate, the solvent evaporates and the binder (alternatively referred to as a resin) holds the enhancement particles together to form a dry film on the substrate. The enhancement particles can provide surface enhancements for the measurement techniques described herein.

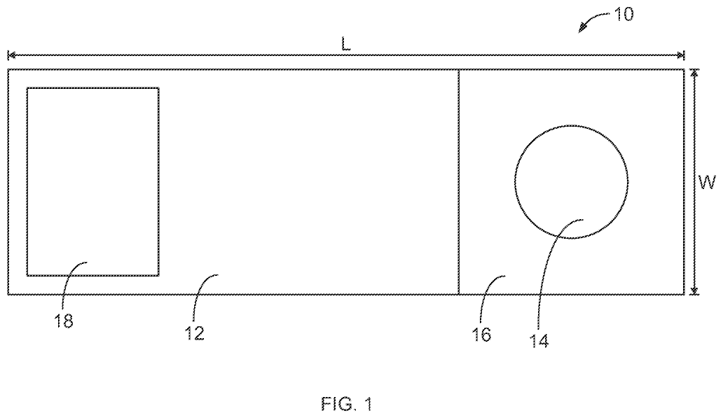

Referring to FIG. 1, in certain examples, a coated substrate 10 is prepared for use in a surface-enhanced Raman spectroscopy (SERS) process. The coated substrate 10 includes a substrate 12 and a layer of paint 14 disposed on or coating the substrate 10. The substrate 10 can be or include, for example, a glass microscope slide or other suitable substrate, such as a concave sample well, a vial, a well plate, paper, a membrane, or a porous material. The substrate 10 can have a length L of about 75 mm (about 3 inches), a width W of about 25 mm (about 1 inch), and a thickness of about 1-2 mm. Other dimensions for the substrate 10 are contemplated.

The paint 14 includes a collection or dispersion of enhancement particles, which can be microparticles and/or nanoparticles, such as, for example, metallic nanoparticles. The microparticles can have a size (e.g., a diameter) from about 0.1 μm to about 100 μm. The nanoparticles can have a size from about 1 nm to about 100 nm. In various examples, the enhancement particles can include or be made of silver, gold, nickel, copper, platinum, aluminum, or other metal. In some examples, the enhancement particles can include or be made of carbon, such as carbon nanotubes, as well as a range of other photonically excitable materials. The enhancement particles can be substantially spherical in shape, substantially cylindrical in shape (e.g., fibers or tubes), flake shaped, star shaped, cone shaped, or can have a random or irregular shape. The enhancement particles can have a distribution of shapes and/or sizes. In one example, the enhancement particles can be or include flakes of metal (e.g., silver) and/or can have an average diameter of about 8 microns. The layer of paint 14 on the substrate 10 can have a thickness from about 25 microns (1 mil) to about 254 microns (10 mils), from about 102 microns (4 mils) to about 178 microns (7 mils), or about 127 microns (5 mils), before or after the paint has dried.

In certain implementations, the paint (alternatively referred to as “ink”) can include enhancement particles (e.g., of silver, gold, nickel, copper, carbon, or other material) suspended in a liquid medium, which can be water-based or oil-based. A suitable paint or paint precursor is a water-based, silver-filled, conductive ink/paint. The paint can have a viscosity (#5 RV Spindle, 20 rpm 25° C.) of about 1500 cps and a total % NV (non-volatile) solids of about 76%. In some examples, the water content, particle density, and/or viscosity of the paint can be adjusted in an effort to improve results obtained with SERS. For example, the paint can be thinned or diluted by adding water (e.g., distilled water) to achieve a total % NV solids less than about 76%, such as about 70%, about 60%, about 50%, about 40%, about 30%, or about 20%. Alternatively, before the paint is applied to a substrate, water can be removed to achieve a total % NV solids greater than about 76%, such as about 80%, or about 90%. Adjusting the water content of the paint can facilitate the painting/coating process and/or result in desired coating thicknesses, coating properties, and/or surface textures, as well as laser resonance. Post-processing steps such as freeze-drying can enhance SERS measurement accuracy, as described herein.

Table 1 includes example low, high, and typical values for the weight percentages of the components present in the paint (e.g., during the painting/coating process). Each listed value or value within a listed range can be a minimum, maximum, or average value. Various embodiments include any parameter value (e.g., integer or decimal value) within the cited ranges. For example, a weight percentage (wt %) of the enhancement particles in the paint can be less than, greater than, or equal to 20, 21, 22, . . . , 79, or 80 wt %. Likewise, the weight percentage of the binder in the paint can be less than, greater than, or equal to 5, 6, 7, . . . , 39, or 40 wt %. Express support and written description of these parameter values for each parameter are hereby represented.

TABLE 1
Exemplary paint compositions.

| Ingredient | Low | Typical | High |
|---|---|---|---|
| Enhancement Particles (wt %) | 20 | 65 | 80 |
| Binder (wt %) | 5 | 10 | 40 |
| Solvent (wt %) | 5 | 23 | 50 |
| Additives (wt %) | 1 | 2 | 10 |

In the depicted example, the paint 14 is disposed on the substrate 10 in a circular region and is bounded on one or more sides by an isolator 16. The isolator 16 can be made of silicone, rubber, or other polymeric materials. In certain implementations, the isolator 16 can be made of a low surface energy material, a non-wetting material, or a hydrophobic barrier that can help confine a test sample to the region of paint 14. For example, when a liquid test sample is applied to the paint 14, the isolator 16 can prevent the test sample from flowing or moving to a region outside of the paint 14 or a painted laser target area. Alternatively or additionally, in some examples, the test sample can be contained on the substrate 10 without using the isolator 16. For example, the substrate 10 can have a concave surface (e.g., a sample well, as in a 96 well plate), a sample vial, a textured surface, a porous surface (e.g., a porous membrane or surface textured material), or other feature that can contain the test sample.

The coated substrate 10 also includes a label 18 that can be used to identify the coated substrate 10 and/or a test sample on the coated substrate 10. The label 18 can include a bar code, a serial number, or other identifier.

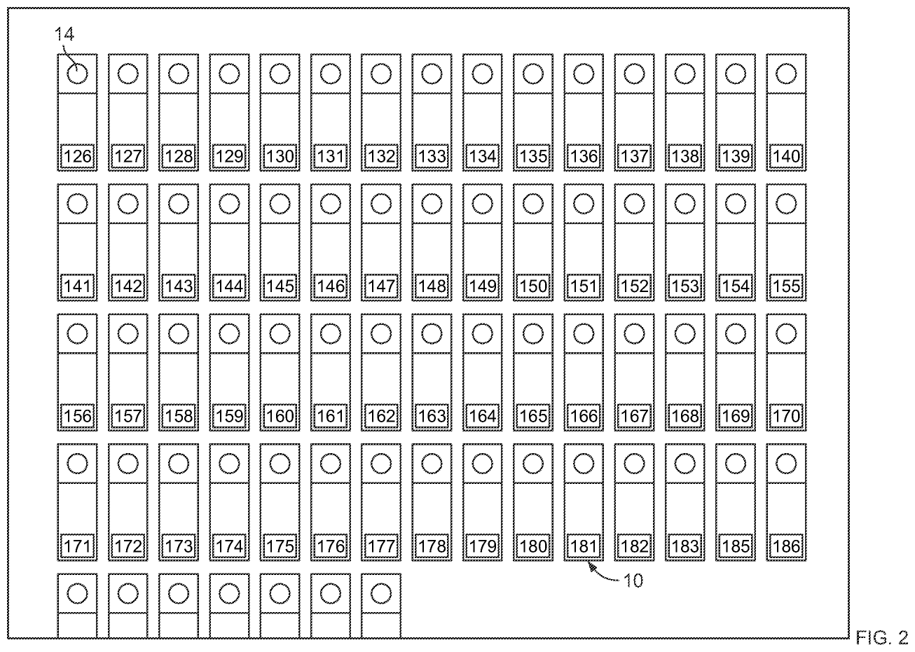

FIG. 2 includes a photograph of a collection of coated substrates 10. Each coated substrate 10 in this figure includes a circular region of the paint 14.

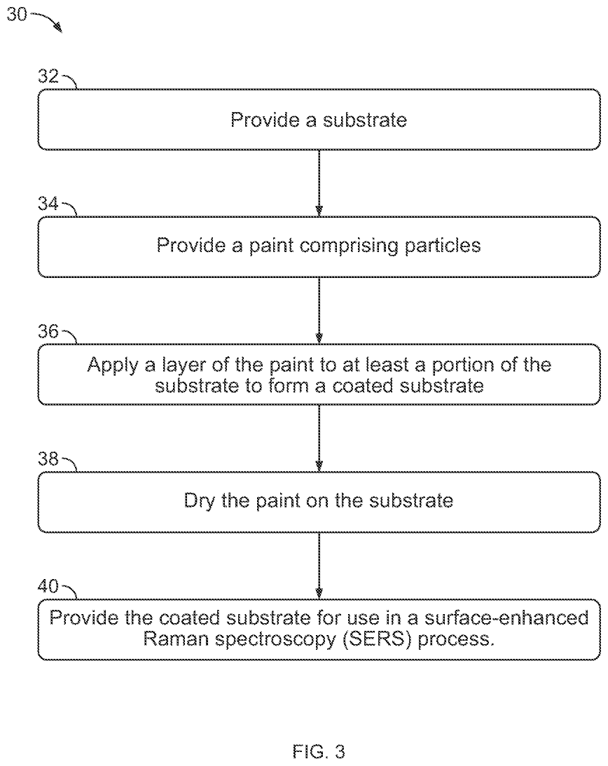

FIG. 3 includes a flowchart of a method 30 of manufacturing a coated substrate, such as the coated substrate 10. The method 30 includes providing (step 32) a substrate (e.g., the substrate 12) and providing (step 34) a paint containing microparticles and/or nanoparticles (e.g., the paint 14). A layer of the paint 14 is applied (step 36) to at least a portion of the substrate to form a coated substrate. A variety of coating techniques can be used to apply the paint to the substrate. For example, the paint can be applied using spray coating, roll coating, brush coating, dip coating, blade coating, or curtain coating. The coating technique can be configured to apply the paint to only a portion of the substrate (e.g., a circular region). A mask can be used to confine the paint to the desired portion of the substrate. In some examples, a silicone isolator can serve as a suitable mask.

It can be helpful in some instances to achieve a textured paint surface (e.g., through coating techniques or subsequent roughening of the surface), to enhance optical properties and improve results obtained with SERS. In one example, after or during paint application (e.g., during a subsequent drying step), the substrate and paint can be subjected to a mechanical oscillation, shaking, vibration, or other agitation that forms small rivulets, ridges, or waves in the paint layer (e.g., due to forward and reverse flow of the paint). The resulting texture can dramatically enhance a signal obtained from SERS.

The layer of paint on the substrate can be allowed to dry (step 38), which can involve evaporating a liquid (e.g., water, paint thinner, or other solvent) from the paint. Resins present in the paint can coalesce and/or harden to form a dry binder containing the microparticles and/or nanoparticles.

In some examples, the paint can be dried through use of freeze-drying, which can involve freezing the layer of paint and allowing ice (or other materials or solvents) to sublimate from the layer (e.g., at reduced pressure). Advantageously, use of freeze-drying can achieve a surface structure, surface roughness, and/or porosity (e.g., micropores) that further enhance signals achieved through SERS, compared to paint layers that are dried using other techniques. Freeze drying has been found to significantly improve SERS measurement accuracy (e.g., by 25%, 50%, or more).

The dried paint on the substrate can then be used in a SERS process (step 40). For example, a test sample can be applied to the painted region. The test sample can be or include, for example, a liquid material (e.g., a bodily fluid, such as blood, saliva, or urine), a solid material (e.g., a powder), or combinations thereof. The test sample can be collected from a person, an object (e.g., luggage or clothing), or other item or area. The SERS process can be used to detect a component in the test sample, such as a molecule, a virus, a biological agent, a disease state (e.g., an indication that an individual has a disease), a protein, a biomarker, an explosive, contraband, an impurity, a chemical spectral fingerprint, a biological spectral fingerprint, etc. The coated substrate and the SERS process has applications in medical diagnostics (e.g., virus detection), chemical and biological threat detection, explosives detection, contraband detection, drug or intoxicant detection, impurity detection, precision agriculture, molecular testing, and industrial process control.

In certain instances, constituents of the paint (e.g., binders, enhancement particles, etc.) can be detected in the SERS process or can otherwise appear in SERS measurement results. To compensate for this, the SERS equipment and/or data processing techniques can be calibrated to recognize and subtract a fingerprint or background signal associated with the paint. This can be achieved by taking SERS readings on one or more blank substrates that include paint but no test sample. Additionally or alternatively, machine learning techniques can be used to determine the fingerprint or background signal, or to differentiate between the paint and the test sample. For example, a machine learning model can be trained with a large volume of SERS data corresponding to a wide variety of sample types on one or more types of paint layers. This can enable the machine learning model to distinguish SERS signals associated with paint from SERS signals associated with test samples. In some implementations, the SERS signals associated with the paint can be subtracted from an overall signal to determine a signal for a test sample. Additionally or alternatively, the machine learning model can be used to extract the test sample signal from the overall SERS signal (e.g., by recognizing the paint signal in the overall signal). In some instances, the paint can be tailored to include constituents, such as enhancement particles and/or binders, that serve as reference peaks against which a sample analyte placed on the paint can be measured.

The SERS process can utilize a variety of device settings and system components. In some examples, a power setting of 750 mA, a laser power of 200 mW, and a scan or integration time of 1500 ms can achieve suitable results. Advantageously, unlike SERS processes used with previous substrates, the SERS process for the coated substrates described herein can expose the substrates directly using a fiber optic and does not require a microscope. By not requiring a microscope, the spectrometer can be smaller, less expensive, and easier to use.

In various examples, the method 30 can include forming an isolator (e.g., the isolator 16) adjacent to or surrounding the paint. The isolator can be or include a piece of silicone having a circular opening (e.g., about 10 mm in diameter) and an adhesive backing. The isolator can be adhered to the substrate before or after the paint has been applied. Alternatively or additionally, the isolator can be formed by applying a coating of silicone or other suitable isolator material to the substrate.

In some instances, a label can be applied to the substrate. The label can be or include a sticker containing information for identifying the coated substrate and/or the test sample.

In certain examples, when the enhancement particles included in the paint are susceptible to oxidation or other forms of degradation, it can be desirable to take steps to minimize or prevent such degradation, to ensure the paint performs well for SERS. In some instances, for example, the coated substrate and/or related manufacturing process can be subjected to or performed in an environment that is isolated from oxygen or other substances that can cause the degradation. This can involve, for example, packaging the coated substrate in a sealed container (e.g., an envelope) that contains little or no oxygen. Alternatively or additionally, the paint on the coated substrate can be covered with one or more layers of impermeable materials. Further, in some examples, the coating technique can be performed in a low-oxygen environment (e.g., using an inert gas such as nitrogen as a propellant for spray coating) and/or the coated substrate can be dried in a low oxygen environment. Suitable drying environments can include, for example, a desiccator filled with inert gas (e.g., nitrogen) or a vacuum (e.g., a freeze-drying apparatus). The coated substrate can be packaged in single packs with anti-corrosion (e.g., anti-tarnish) paper. The coated substrate can be vacuum sealed in mylar (e.g., following a nitrogen purge). An end-to-end nitrogen (or other inert gas) process can be used to prevent oxidation. A variety of inert gases can be used to prevent or minimize degradation, such as, for example, nitrogen, argon, and/or helium.

The techniques described herein for applying microparticles and/or nanoparticles to a substrate for use in SERS has several advantages over previous techniques, which typically involve the use of sputtering, physical vapor deposition, crystalline growth, chemical mixing, liquid adsorption, electrochemistry, electroplating, or similar techniques to deposit metal particles on silicon chips, paper test strips, or other substrates. For example, the microparticles and/or nanoparticles used in the paint can be produced by milling and/or grinding bulk materials (e.g., metals), rather than precision-formed through high tech processes. Suitable and widely available paint binders and/or solvents can be mixed with the milled materials, resulting in a large volume of paint containing the microparticles and/or nanoparticles. This enables mass production of substrates using a variety of painting and coating methods. In general, the techniques described herein for applying microparticles and/or nanoparticles to a substrate for use in SERS are much faster (e.g., reduce coated substrate preparation time by a factor of 2, 10, or more) and more cost-effective, while maintaining substrate homogeneity, uniformity, and repeatability. Use of the paint and coating techniques described herein can achieve mass production and mass adoption of SERS in a manner that is not feasible for other, more technologically intensive or complicated approaches. Mass production of suitable SERS substrates can transition SERS techniques from small-scale experiments in research laboratories (e.g., for disease detection) to mass adoption by consumers (e.g., for point-of-care medical testing or self-administered medical testing).

Another advantage of the techniques described herein is that measurements can be taken with test samples that are wet. For example, a sample of liquid saliva or blood can be placed on the paint layer, and accurate and repeatable SERS measurements can be obtained while the sample is in a liquid state. With previous approaches, the sample generally needs to be dried before accurate and repeatable SERS measurements are obtainable.

Another surprising advantage of the techniques described herein is that measurement accuracy can be improved due to the paint introducing a large fingerprint in the SERS signal (e.g., 95% of the total signal). Conventional wisdom is that it is desirable to have almost no SERS signal when there is no test sample present on the substrate. With techniques described herein, however, the paint can introduce large signals that achieve more accurate results. For example, the paint signal can serve as a reference point against which a signal from the test sample can be determined. A paint signal having multiple peaks or spikes distributed across the Raman spectrum can lead to more accurate measurements of the test sample.

In various examples, the paint described herein includes enhancement particles (alternatively referred to as surface enhancement particles) suspended in a mixture of binder, solvent, and additives. When applied to a substrate and dried, the paint and the binder can hold the surface enhancement particles together in a dry layer on a substrate. This is distinct from previous methods of applying surface enhancement particles in liquid solution, in which, absent a binder or other paint additives, particles and solvent are simply placed on a substrate (e.g., paper) and allowed to dry without otherwise binding or adhering. Such prior methods may utilize colloidal gold or silver without a binder, such that the particles are incapable of clinging to most substrate materials. Binders (and other paint ingredients) have been excluded from prior surface enhancement materials for SERS because it was thought that the binders can interfere with optical signatures of the samples being analyzed. It was previously understood, for example, that paint ingredients (e.g., binders, adhesives, or particles) introduce spectrographic signatures that can obscure, occlude, or fluoresce, thereby making target analytes undetectable. Advantageously and surprisingly, however, the techniques and results described herein demonstrate that paint ingredients can provide spectral features that serve as reference points against which analytes can be measured more accurately. The use of paint and related techniques described herein can significantly improve SERS measurement accuracy.

Further, compared to previous surface enhancement approaches, use of the techniques and materials described herein can ensure uniform enhancement particle sizes and dispersions on coated substrates. This improvement provides an even distribution of enhancement particle sizes and morphologies across the surface so that sizes and morphologies no longer need to be tightly controlled. Hence, simpler and more efficient enhancement particle production methods such as grinding of bulk metals can be applied as opposed to more precise methods. Further, enhancement particle sizes can be larger compared to previous techniques. This can dramatically reduce the cost and improve the efficiency of SERS substrate manufacturing processes.

A variety of optimization and quality control techniques were used to evaluate and develop the materials, methods, and systems described herein. For example, viscometric, colorimetric, conductive, spectrographic, and digital microscopic image processing techniques were used to determine or measure various characteristics of the paint, including uniformity, film thickness, surface texture, water content, and total dissolved solids. Blank substrates (e.g., paint on a glass microscope slide) were scanned using a spectrometer, and the resulting spectra were used to determine a coefficient of variation for the blank substrates. Additionally, standardized chemical and biological samples were placed on the substrates and scanned with the spectrometer to determine repeatability, signal-to-noise ratio, and suitability for precision detection. In one test involving approximately 2,372 biological samples, it was confirmed that the substrates described herein enable viral detection with at least 98.4% accuracy, with 99.6% sensitivity and 98.1% specificity. By comparison, commercially available substrates produced using colloidal gold on paper were found to have a viral detection accuracy of about 60%, due to variability and heterogeneity of the substrates. Unlike the painted substrates described herein, these commercially available substrates were found to be variable across many quality control measures, including reflectivity, color, texture, and distribution of particles. Other commercially available substrates produced using electroplating and/or laser surfacing, and silicon wafers having plasma coatings, vapor deposition coatings, or sputtered coatings resulted in even lower accuracy (e.g., less than 60%) and produced excessive fluorescence or noise. These commercially available substrates are also considerably more expensive.

Further, the painted substrates described herein have been tested at regular time intervals in an effort to evaluate degradation and optimize shelf stability. The testing was used to develop techniques that can minimize oxidation or other degradation processes, for example, through use of inert gases (e.g., nitrogen) or low-oxygen environments during substrate processing, packaging, and handling, as described herein.

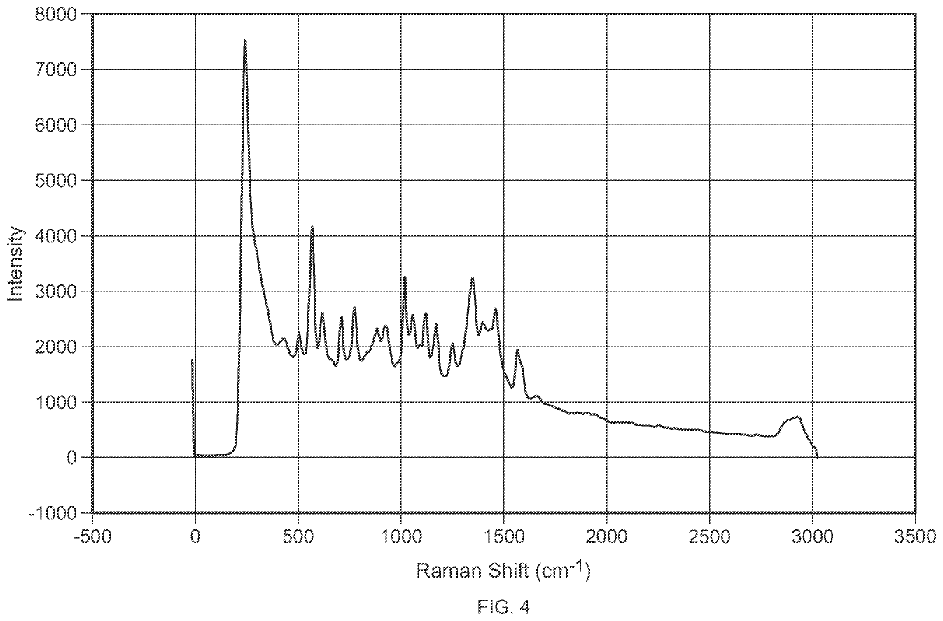

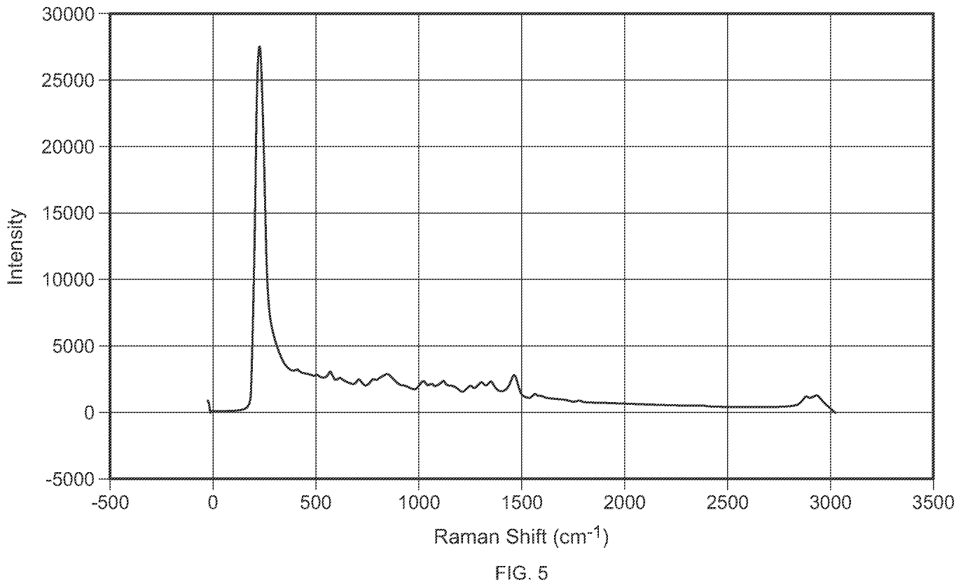

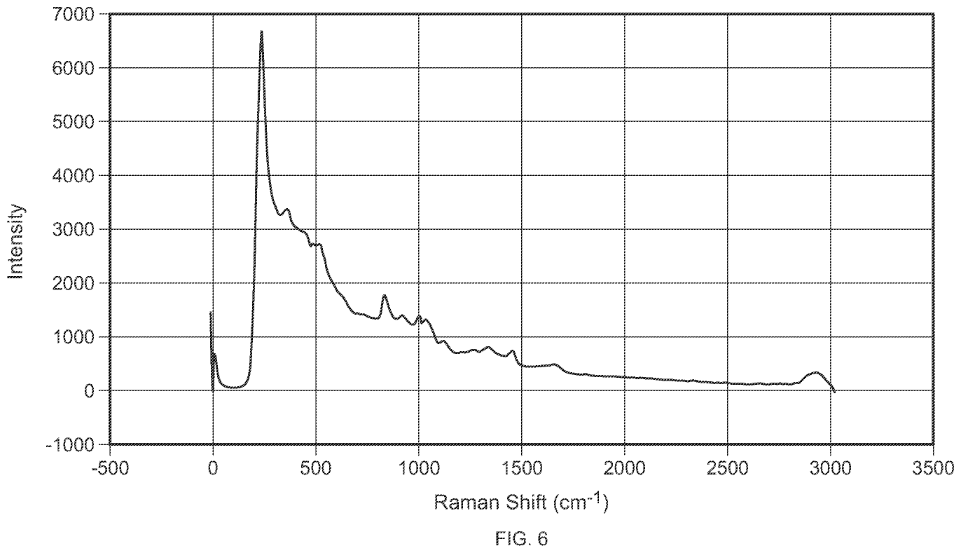

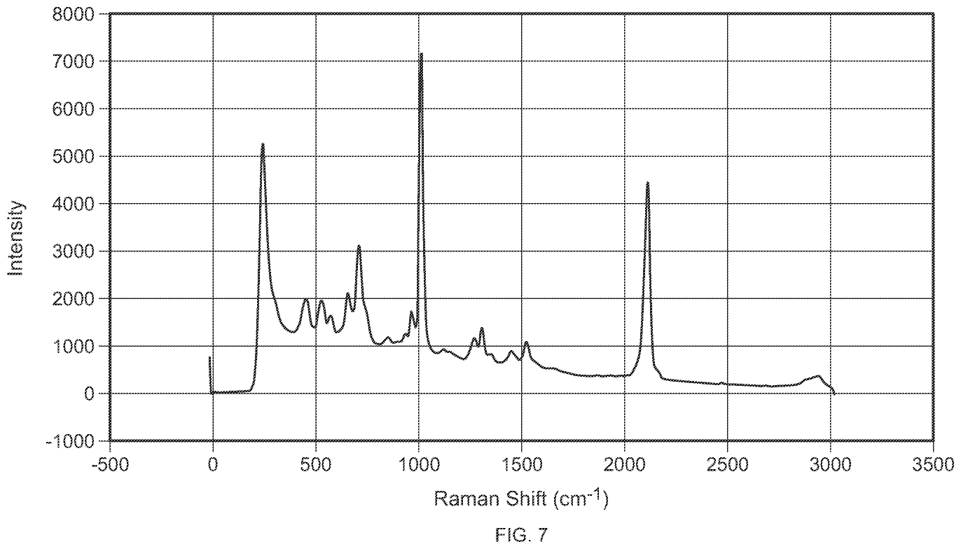

FIGS. 4-7 include plots of SERS spectra obtained using the systems and methods described herein. FIG. 4 depicts a spectrum obtained using a painted substrate without a test sample. FIGS. 5-7 depict three spectra obtained using painted substrates with each substrate having a different type of test sample. The results in these figures indicate that the spectra include features introduced by the paint and by the test samples, and that the spectra generated for the test samples (in FIGS. 5-7) include features that are not present in the spectrum for pure paint (in FIG. 4). As described herein, the spectra generated for the test samples (in FIGS. 5-7) can be compared (e.g., using machine learning) with the spectrum obtained using only paint (in FIG. 4) to isolate the spectral features introduced by the test samples. The isolated spectral features for each test sample can then be used to identify the composition of the test sample.

### Terminology

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 meters should be considered to have specifically disclosed subranges such as 1 meter, 2 meters, 1-2 meters, less than 2 meters, 10-11 meters, 10-12 meters, 10-13 meters, 10-14 meters, 11-12 meters, 11-13 meters, etc.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments,” or “embodiments” means that a particular feature, structure, characteristic, or function described in connection with the embodiment is included in at least one embodiment of the invention and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the term “about”, the phrase “approximately equal to”, and other similar terms or phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

“Machine learning” generally refers to the application of certain techniques (e.g., pattern recognition and/or statistical inference techniques) by computer systems to perform specific tasks. Machine learning techniques may be used to build models based on sample data (e.g., “training data”) and to validate the models using validation data (e.g., “testing data”). The sample and validation data may be organized as sets of records (e.g., “observations” or “data samples”), with each record indicating values of specified data fields (e.g., “independent variables,” “inputs,” “features,” or “predictors”) and corresponding values of other data fields (e.g., “dependent variables,” “outputs,” or “targets”). Machine learning techniques, such as neural networks, evolutionary computation, random forest, linear discriminate analysis, etc. may be used to train models to infer the values of the outputs based on the values of the inputs. When presented with other data (e.g., “inference data”) similar to or related to the sample data, such models may accurately infer the unknown values of the targets of the inference data set.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention.

The features and functions of the various embodiments may be arranged in various combinations and permutations, and all are considered to be within the scope of the disclosed invention. Accordingly, the described embodiments are to be considered in all respects as only illustrative and not restrictive. Furthermore, the configurations, materials, and dimensions described herein are intended as illustrative and in no way limiting. Similarly, although physical explanations have been provided for explanatory purposes, there is no intent to be bound by any particular theory or mechanism, or to limit the claims in accordance therewith.

What is claimed is:

1. A method comprising:
providing a substrate;
providing a paint comprising enhancement particles; and
applying a layer of the paint to at least a portion of the substrate to form a coated substrate, wherein the coated substrate is configured for use in a surface-enhanced Raman spectroscopy (SERS) process.

2. The method of claim 1, wherein the substrate comprises a microscope slide.

3. The method of claim 1, wherein the enhancement particles comprise metallic microparticles or metallic nanoparticles.

4. The method of claim 1, wherein the paint further comprises a binder.

5. The method of claim 1, wherein applying the layer of the paint comprises using a coating process, and wherein the coating process comprises at least one of spray coating, roll coating, brush coating, dip coating, blade coating, or curtain coating.

6. The method of claim 1, wherein providing the coated microscope slide for use in the SERS process comprises preventing oxidation of the enhancement particles.

7. The method of claim 1, wherein the SERS process is used to detect a component in a test sample disposed on the paint.

8. The method of claim 7, wherein the component comprises at least one of a molecule, a virus, a biological agent, a disease state, a protein, a biomarker, an explosive, contraband, a chemical agent, an industrial chemical, a bacterium, a polymer, an impurity, a component related to process chemistry quality control, a molecular artifact, a chemical spectral fingerprint, a biological spectral fingerprint, or any combination thereof.

9. The method of claim 1, wherein the substrate comprises a sample containment feature, and wherein the sample containment feature comprises at least one of a silicone isolator, a concave surface, a sample well, a sample vial, a textured surface, a porous surface, or a porous membrane.

10. A method comprising:
obtaining a coated substrate having a coating of paint comprising enhancement particles;
applying a test sample to the paint; and
using surface-enhanced Raman spectroscopy (SERS) to detect a component in the test sample.

11. The method of claim 10, wherein the coated substrate comprises at least one of a microscope slide, a silicone isolator, a concave sample well, a vial, a well plate, paper, a membrane, or a porous material.

12. The method of claim 10, wherein the enhancement particles comprise metallic microparticles or metallic nanoparticles.

13. The method of claim 10, wherein the component comprises at least one of a molecule, a virus, a biological agent, a disease state, a protein, a biomarker, an explosive, contraband, a chemical agent, an industrial chemical, a bacterium, a polymer, an impurity, a molecular artifact, a component related to process chemistry quality control, a chemical spectral fingerprint, a biological spectral fingerprint, or any combination thereof.

14. A system comprising:
a coated substrate having a coating of paint comprising enhancement particles; and
a surface-enhanced Raman spectroscopy (SERS) device,
wherein a test sample is applied to the paint and the SERS device is used to detect a component in the test sample.

15. The system of claim 14, wherein the enhancement particles comprise metallic microparticles or metallic nanoparticles.

16. The system of claim 14, wherein the component comprises at least one of a molecule, a virus, a biological agent, a disease state, a protein, a biomarker, an explosive, contraband, a chemical agent, an industrial chemical, a bacterium, a polymer, an impurity, a molecular artifact, a component related to process chemistry quality control, or any combination thereof.

17. An apparatus comprising:
a microscope slide; and
a paint disposed on at least a portion of the microscope slide, the paint comprising metallic enhancement particles.

18. The apparatus of claim 17, wherein the metallic enhancement particles comprise silver.

19. The apparatus of claim 17, wherein the apparatus is configured for use in a surface-enhanced Raman spectroscopy (SERS) device.

20. The apparatus of claim 17, further comprising a silicone isolator disposed on the microscope slide and surrounding at least a portion of the paint.
